(19) United States
(12) Patent Application Publication
(10) Pub. No.: US 2015/0098847 A1
(43) Pub. Date: Apr. 9, 2015

(54) ELECTRIC VACUUM PUMP

(71) Applicant: AISAN KOGYO KABUSHIKI KAISHA, Obu-shi (JP)

(72) Inventors: Atsushi SUGIMOTO, Obu-shi (JP); Katsuhiko MAKINO, Chita-gun (JP); Shota YAMANAKA, Nagoya-shi (JP)

(21) Appl. No.: 14/505,050

(22) Filed: Oct. 2, 2014

(30) Foreign Application Priority Data
Oct. 3, 2013 (JP) 2013-207982

(51) Int. Cl. F04D 25/06; B60T 13/10; F04D 19/04

(52) U.S. Cl. CPC F04D 25/068; F04D 19/04; B60T 13/10
USPC 417/423.12

(57) ABSTRACT

An electric vacuum pump includes a rotary member including an armature and a commutator; a brush arranged to slide in contact with the commutator; a motor part provided with a rotary shaft integral with the rotary member; a pump part connected to the rotary shaft and configured to operate in sync with the motor part; and a bearing supporting the rotary shaft between the motor part and the pump part, the commutator and the brush being placed on a non-pump side opposite to a pump side on which the pump part is placed in an axial direction of the rotary shaft with respect to the armature.

### CROSS-REFERENCE TO RELATED APPLICATIONS

This application is based upon and claims the benefit of priority from the prior Japanese Patent Application No. 2013-207982 filed on Oct. 3, 2013, the entire contents of which are incorporated herein by reference.

### BACKGROUND OF THE INVENTION

1. Field of the Invention

The present invention relates to a vacuum pump for generating negative pressure to be used in a brake booster of a vehicle such as a car.

2. Related Art

An automotive braking device is provided with a brake booster for amplifying braking force by utilizing negative pressure in an intake pipe of an engine. In recent years, pumping loss has been reduced in response to a demand for good mileage. This results in a tendency for intake-pipe negative pressure to be smaller. In a hybrid vehicle, an electric vehicle, or a vehicle with an idling stop function, the intake-pipe negative pressure of an engine may not be obtained.

Therefore, the negative pressure to be supplied to a brake booster would be generated by use of an electric vacuum pump. Even in a vehicle mounted with a diesel engine that generates no intake-pipe negative pressure, the negative pressure is generated by use of an electric vacuum pump.

As one example of such a vacuum pump, a vacuum pump in Patent Document 1 for example includes a motor part provided with a commutator, a brush, and an armature, a pump part to be operated in sync with the motor part, and a bearing placed between the motor part and the pump part. In this vacuum pump in Patent Document 1, the commutator and the brush of the motor part are placed in positions closer to the pump part than the armature.

### RELATED ART DOCUMENTS

### Patent Documents

Patent Document 1: JP-A-2010-151065

### SUMMARY OF INVENTION

### Problems to be Solved by the Invention

However, the vacuum pump in Patent Document 1 may generate motor foreign matter such as abrasion powder from the commutator and the brush due to sliding between the commutator and the brush during operation of the pump. The thus generated motor foreign matter is sucked toward the pump part by the negative pressure generated in the pump part and may flow in or enter the bearing placed between the motor part and the pump part. This increases sliding resistance in the bearing. Furthermore, when the motor foreign matter adheres to the bearing, the motor part is locked and stopped. Thus, the vacuum pump in Patent Document 1 may not operate stably.

The present invention has been made to solve the above problems and has a purpose to provide an electric vacuum pump that can operate stably.

### Means of Solving the Problems

To achieve the above purpose, one aspect of the invention provides an electric vacuum pump including: a rotary member including an armature and a commutator; a brush arranged to slide in contact with the commutator; a motor part provided with a rotary shaft integral with the rotary member; a pump part connected to the rotary shaft and configured to operate in sync with the motor part; and a bearing supporting the rotary shaft between the motor part and the pump part, the commutator and the brush being placed on a non-pump side opposite to a pump side on which the pump part is placed in an axial direction of the rotary shaft with respect to the armature.

According to the above aspect, the commutator and the brush are placed away from the bearing located between the motor part and the pump part. Accordingly, motor foreign matter such as abrasion powder possibly generated from the commutator and the brush due to sliding of the commutator against the brush are less likely to flow in the bearing. Furthermore, the armature which is a rotor is placed between the bearing and a set of the commutator and the brush. Thus, the motor foreign matter is much less likely to enter the bearing. Consequently, the performance of the bearing can be maintained, thereby enabling stable operation of the electric vacuum pump.

### BRIEF DESCRIPTION OF THE DRAWINGS

FIG. 1 is a schematic configuration view of a brake system including an electric vacuum pump of an embodiment;

FIG. 2 is a block diagram showing a control system of the brake system including the electric vacuum pump of the embodiment;

FIG. 3 is a cross sectional view of an electric vacuum pump in Examples 1 to 3;

FIG. 4 is a side view of an armature, a commutator, and a shaft in Example 2;

FIG. 5 is a side view of an armature, a commutator, and a shaft in Example 3;

FIG. 6 is a side view of an armature, a commutator, and a shaft in a variation of Example 3;

FIG. 7 is a part of a top view of the armature shown in FIG. 6;

FIG. 8 is a cross sectional view of an electric vacuum pump in Example 4;

FIG. 9 is a cross sectional view of an electric vacuum pump in a variation of Example 4

FIG. 10 is a cross sectional view of an electric vacuum pump in Example 5;

FIG. 11 is an external perspective view of an armature, a commutator, and a shaft in Example 5;

FIG. 12 is a cross sectional view taken along A-A in FIG. 11;

FIG. 13 is an external perspective view of an armature, a commutator, and a shaft in Example 6; and

FIG. 14 is an exploded perspective view of the armature, the commutator, and the shaft in Example 6.

### DESCRIPTION OF EMBODIMENTS

A detailed description of an embodiment of an electric vacuum pump embodying the present invention will now be given referring to the accompanying drawings. In the present embodiment explained below, the electric vacuum pump of the invention is applied to a brake system.

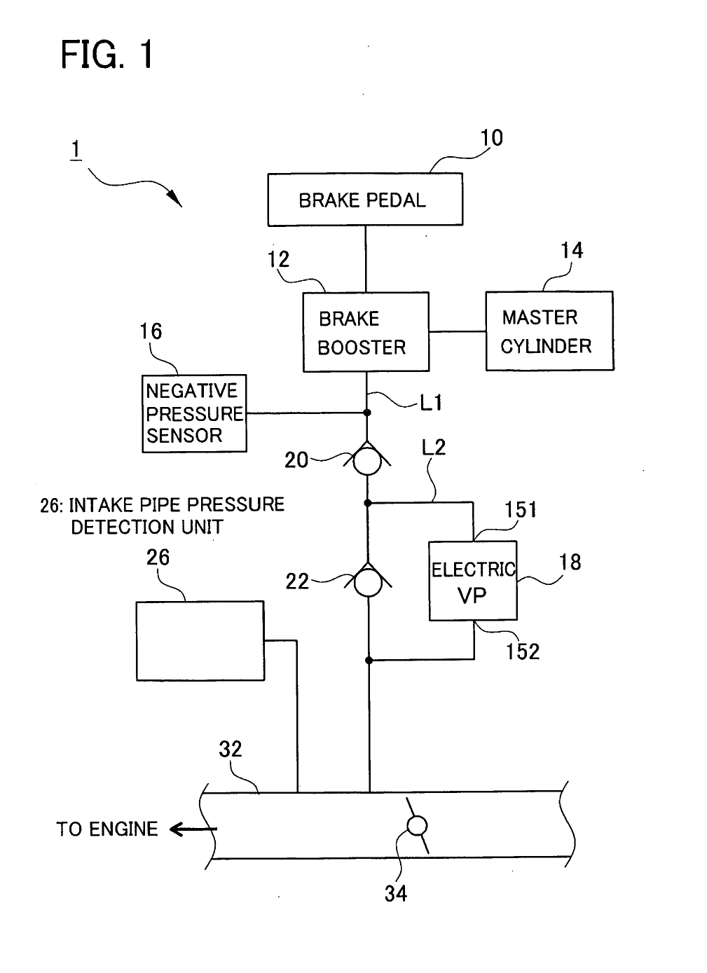

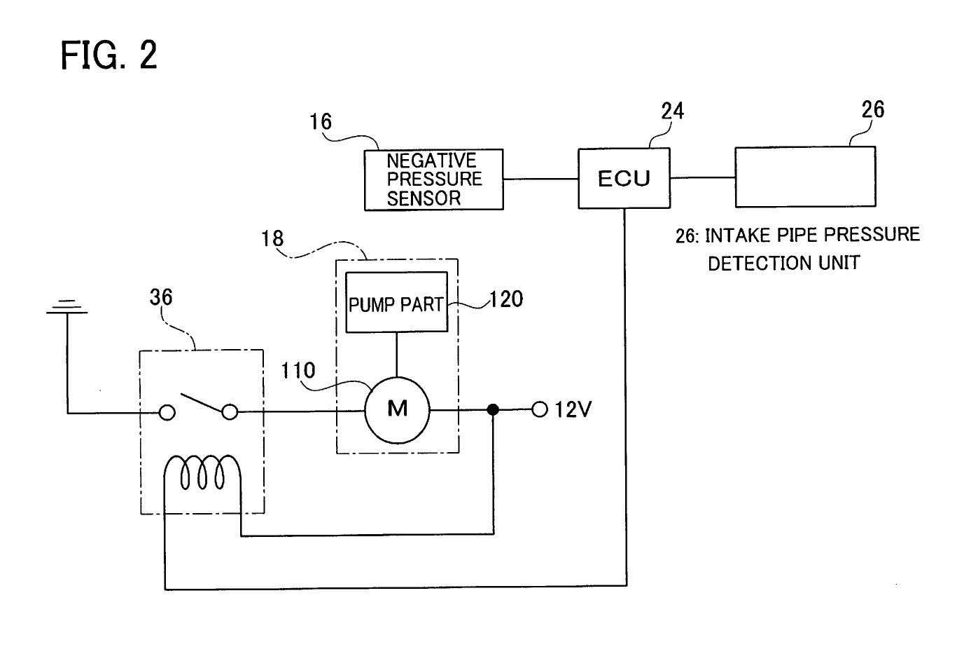

The brake system will be first explained referring to FIGS. 1 and 2. FIG. 1 is a schematic configuration view of a brake system including the electric vacuum pump of the present embodiment. FIG. 2 is a block diagram showing a control system of the brake system including the electric vacuum pump of the present embodiment.

A brake system 1 of this embodiment includes, as shown in FIGS. 1 and 2, a brake pedal 10, a brake booster 12, a master cylinder 14, a negative pressure sensor 16, an electric vacuum pump 18 (labeled “Electric VP” in the figure), a first check valve 20, a second check valve 22, an ECU 24, an intake pipe pressure detection unit 26, and others.

The brake booster 12 is provided between the brake pedal 10 and the master cylinder 14 as shown in FIG. 1. This brake booster 12 is arranged to generate an assist force at a predetermined boosting ratio to a tread force on the brake pedal 10.

The brake booster 12 is internally partitioned by a diaphragm (not illustrated) into a negative pressure chamber (not shown) close to the master cylinder 14 and a transformer chamber (not shown) allowing introduction of atmospheric air. The negative pressure chamber of the brake booster 12 is connected to an intake pipe 32 of an engine through a first passage L1. That is, the first passage L1 is connected to the negative pressure chamber of the brake booster 12 and the intake pipe 32. Accordingly, the negative pressure chamber of the brake booster 12 is supplied with negative pressure generated in the intake pipe 32 through the first passage L1 according to an opening degree of a throttle valve 34 during driving of the engine.

The master cylinder 14 increases hydraulic pressure of a brake main body (not shown) by operation of the brake booster 12, thereby generating a braking force in the brake main body. The negative pressure sensor 16 detects the negative pressure in the negative pressure chamber of the brake booster 12.

The electric vacuum pump 18 is connected to a second passage L2 as shown in FIG. 1. Specifically, a suction port 151 of the electric vacuum pump 18 is connected to the negative pressure chamber of the brake booster 12 through the second passage L2 and the first passage L1. It is to be noted that a discharge port 152 of the electric vacuum pump 18 is connected to the first passage L1 on a side closer to the intake pipe 32 than the second check valve 22. Herein, the second passage L2 is a pathway for branching from the first passage L1 at a position on the first passage L1 between the first check valve 20 and the second check valve 22.

The electric vacuum pump 18 is further connected to the ECU 24 through a relay 36 as shown in FIG. 2. Driving of the electric vacuum pump 18 is controlled by ON/OFF operation of the relay 36 by the ECU 24.

The first check valve 20 is provided in the first passage L1 at a position between a branch point to the second passage L2 and the brake booster 12. The second check valve 22 is provided in the first passage L1 at a position closer to the intake pipe 32 than the first check valve 20 and between the branch point to the second passage L2 and the intake pipe 32. These first check valve 20 and second check valve 22 are each configured to open only when negative pressure on the side of the intake pipe 32 is higher than the negative pressure on the side of the negative pressure chamber of the brake booster 12 and to permit a fluid to flow only from the negative pressure chamber of the brake booster 12 to the intake pipe 32. In this manner, the brake system 1 can encapsulate negative pressure in the negative pressure chamber of the brake booster 12 by the first check valve 20 and the second check valve 22.

The ECU 24 consists of for example a microcomputer and includes a ROM that stores control programs, a rewritable RAM that stores calculation results and others, a timer, a counter, an input interface, and an output interface. To this ECU 24, as shown in FIG. 2, there are connected the negative pressure sensor 16, the electric vacuum pump 18, the intake pipe pressure detection unit 26, the relay 36, and others.

Next, the electric vacuum pump 18 will be explained.

### Example 1

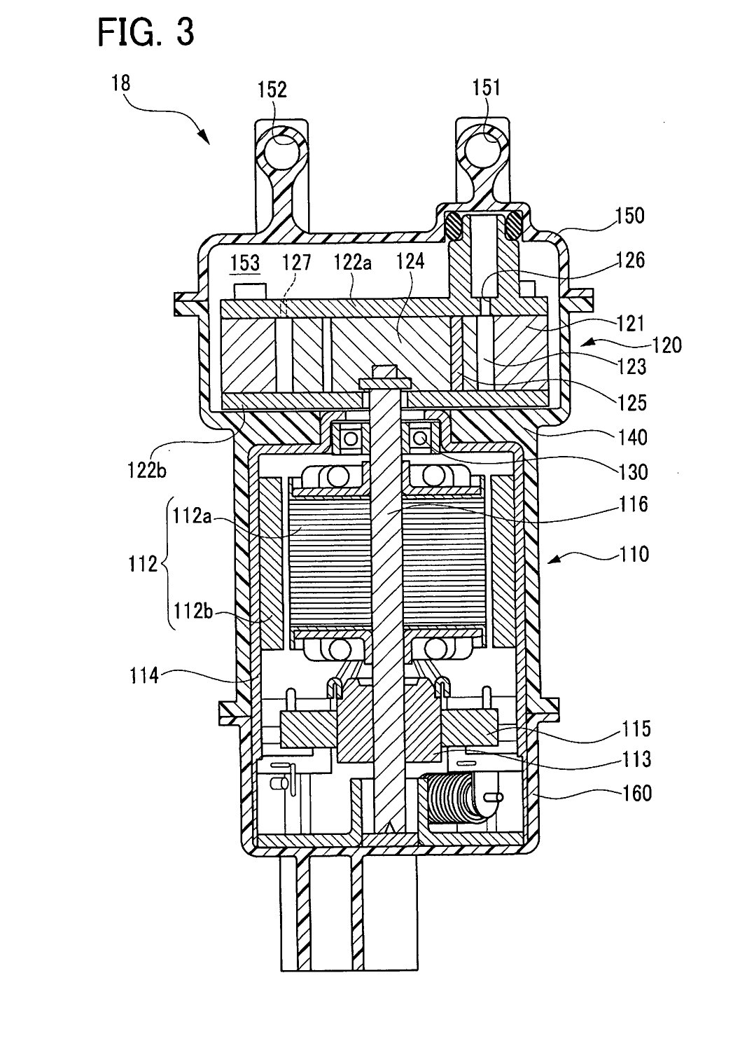

Firstly, Example 1 is explained. FIG. 3 is a cross sectional view of the electric vacuum pump 18 in Examples 1 to 3.

The electric vacuum pump 18 has a cylindrical shape and is provided with the suction port 151 and the discharge port 152 at an upper end as shown in FIG. 3. This electric vacuum pump 18 further includes a motor part 110, a pump part 120, a bearing 130, a resin case 140, a resin upper cover 150, a resin lower cover 160, and others. The motor part 110 and the pump part 120 are housed in the internal space of the case 140. This case 140 is closed by the upper cover 150 and the lower cover 160.

The motor part 110 includes an electric motor 112, a commutator 113, a metal motor case 114, a brush 115, a shaft 116, and others. The electric motor 112 is housed in the motor case 114 and includes an armature (a rotor) 112a and a magnet (a stator) 112b. The magnet 112b is fixed to the motor case 114. The armature 112a is rotatably placed inside the magnet 112b with a clearance therefrom. The armature 112a and the commutator 113 are one example of a “rotary member” of the present invention.

The shaft 116 is integrally attached to the armature 112a and the commutator 113. This shaft 116 is one example of a “rotary shaft” of the present invention.

In the motor part 110, the electric motor 112 is driven by an external power supply, thereby causing the shaft 116 to rotate. The shaft 116 is rotatably supported by the bearing 130 fixed to the motor case 114.

The commutator 113 is attached to the shaft 116. The brush 115 is placed outside the outer peripheral surface of the commutator 113. The brush 115 is configured to relatively slide in contact with the commutator 113 to transmit electric current.

In the present embodiment, as shown in FIG. 3, the commutator 113 and the brush 115 are arranged on an opposite side (a lower side in FIG. 3, or a non-pump side) from a side (an upper side in FIG. 3, or a pump side) on which the pump 120 is located in an axial direction of the shaft 116 (a vertical direction in FIG. 3) with respect to the armature 112a.

The pump part 120 is constituted of a vane-type vacuum pump and is placed above the motor part 110. The pump part 120 is activated in sync with the motor part 110. Herein, the vane-type vacuum pump is configured such that a rotor having a circular columnar shape placed in an eccentric state in a pump chamber is formed with grooves, in which a plurality of vanes are inserted to be movable in a rotor radial direction. When the rotor rotates, the vanes are caused to protrude from the grooves by centrifugal force and slide in contact with the inner peripheral surface of a pump chamber, thereby maintaining hermetical sealing between adjacent pump spaces of the pump chamber. In association therewith, the volume of each closed pump space partitioned by the vanes is increased or decreased, thereby causing suction, compression, and discharge of air, so that negative pressure is generated in the pump chamber.

To be concrete, the pump part 120 is provided with a housing 121 having an inner peripheral surface of a nearly cylindrical shape. The inner peripheral surface of a nearly cylindrical shape represents that the cross section of the housing 121 is defined in a circular shape surrounded by a curved line without being limited to a perfect circular or elliptic shape. Both ends of the housing 121 are closed by circular cover members 122a and 122b, so that a pump chamber 123 is formed by the inner peripheral surface of the housing 121 and the cover members 122a and 122b. The housing 121 is fixed to the case 140.

In the pump chamber 123, a circular columnar rotor 124 is housed to be rotatable about the axis eccentric to the center axis of the pump chamber 123. This rotor 124 is coupled to the shaft 116 of the electric motor 112. Accordingly, the rotor 124 is rotated in sync with rotary driving of the electric motor 112 via the shaft 116.

The rotor 124 has a plurality of vane grooves in each of which, a vane 125 formed in a flat plate shape is slidably engaged to be movable in and out. An end of each vane 125 slides in contact with the inner peripheral surface of the housing 121 by centrifugal force imparted to the vanes 125 during rotation of the rotor 124. Upper and lower end faces of the vanes 125 are in contact with the cover members 122a and 122b respectively. Thus, the vanes 125 partition the pump chamber 123 into a plurality of pump spaces.

The pump chamber 123 communicates with the outside through a suction inlet 126 and a discharge outlet 127. The suction inlet 126 is provided in the cover member 122a to communicate with the pump chamber 123. The suction inlet 126 is a part to suck air from pump outside to pump inside. The discharge outlet 127 is also provided in the cover member 122a to communicate with the pump chamber 123. Exhaust air ejected from the discharge outlet 127 is discharged to the pump outside through the discharge port 152.

The bearing 130 is placed between the motor part 110 and the pump part 120. This bearing 130 supports the shaft 116 in a rotatable state.

The upper cover 150 is a resin member closing an upper open end of the case 140 that houses the motor part 110 and the pump part 120. Specifically, the upper cover 150 closes the case 140 from the pump part side.

The upper cover 150 is provided with the suction port 151 to suck air in the pump part 120 from the pump outside, a silencer part 153 including a space or cavity communicating with the discharge outlet 127 of the pump part 120, and the discharge port 152 to discharge exhaust air discharged or ejected from the pump part 120 to the pump outside.

The silencer part 153 is formed by the internal space of the upper cover 150. Thus, exhaust air discharged or ejected from the discharge outlet 127 of the pump part 120 passes through the silencer part 153 and then is discharged to the pump outside through the discharge port 152.

The lower cover 160 is a resin member closing a lower open end of the case 140 that houses the motor part 110 and the pump part 120. The lower cover 160 closes the case 140 from the motor part side.

In the electric vacuum pump 18 configured as above, when the electric motor 112 is driven to rotate by power externally supplied, the rotor 124 is rotated in synchronization therewith. Then, the vanes 125 slide along the vane grooves by centrifugal force, causing the end faces of the vanes 125 to contact with the inner peripheral surface of the housing 121. While keeping such a contact state, the vanes 125 are rotated along the inner peripheral surface of the housing 121. This rotation of the rotor 124 causes the volume of each pump space of the pump chamber 123 to expand or contract, thereby sucking air into the pump chamber 123 through the suction inlet 126 and ejecting air from the pump chamber 123 through the discharge outlet 127. This operation generates negative pressure in the pump chamber 123.

Specifically, in the brake system 1, when the relay 36 is turned on based on a drive start signal from the ECU 24, the electric vacuum pump 18 starts operating, thereby supplying negative pressure to the negative pressure chamber of the brake booster 12 through the suction port 151, the second passage L2 and the first passage L1. Furthermore, when the relay 36 is turned off based on a drive stop signal from the ECU 24, the electric vacuum pump 18 stops operating, thereby stopping supplying negative pressure to the negative pressure chamber of the brake booster 12 through the suction port 151, the second passage L2 and the first passage L1.

In the brake system 1, while the engine is running and negative pressure is generated in the intake pipe, the negative pressure in the intake pipe 32 is supplied to the negative pressure chamber of the brake booster 12 through the first passage L1. Thus, the negative pressure in the negative pressure chamber of the brake booster 12 can be regulated. In contrast, when the engine is stopped or when the ECU 24 determines that the negative pressure is insufficient, the ECU 24 turns on the relay, thereby driving the electric vacuum pump 18 to supply the negative pressure to the negative pressure chamber of the brake booster 12 through the second passage L2 and the first passage L1. Thus, the negative pressure in the negative pressure chamber of the brake booster 12 can be regulated.

The electric vacuum pump 18 of the present example explained in detail above includes the motor part 110 provided with the rotary member consisting of the armature 112a and the commutator 113, the brush 115 slidable together with the commutator 113, and the shaft 116 integral with the rotary member, the pump part 120 connected to the shaft 116 and configured to operate in sync with the motor part 110, and the bearing 130 supporting the shaft 116 between the motor part 110 and the pump part 120. The commutator 113 and the brush 115 are placed on the non-pump side opposite in the axial direction of the shaft 116 from the pump side on which the pump part 120 is placed with respect to the armature 112a.

The commutator 113 and the brush 115 are placed away from the bearing 130 located between the motor part 110 and the pump part 120. Accordingly, foreign matter such as abrasion powder (hereinafter, referred to as “motor foreign matter”) from the commutator 113 and the brush 115, which may be generated due to sliding between the commutator 113 and the brush 115, are less likely to enter the bearing. Furthermore, the armature 112a which is a rotor is placed between the bearing 130 and a set of the commutator 113 and the brush 115. This generates passage resistance, thereby making the motor foreign matter much less likely to enter the bearing 130. Consequently, the performance of the bearing 130 can be maintained and hence the electric vacuum pump 18 can operate stably.

### Example 2

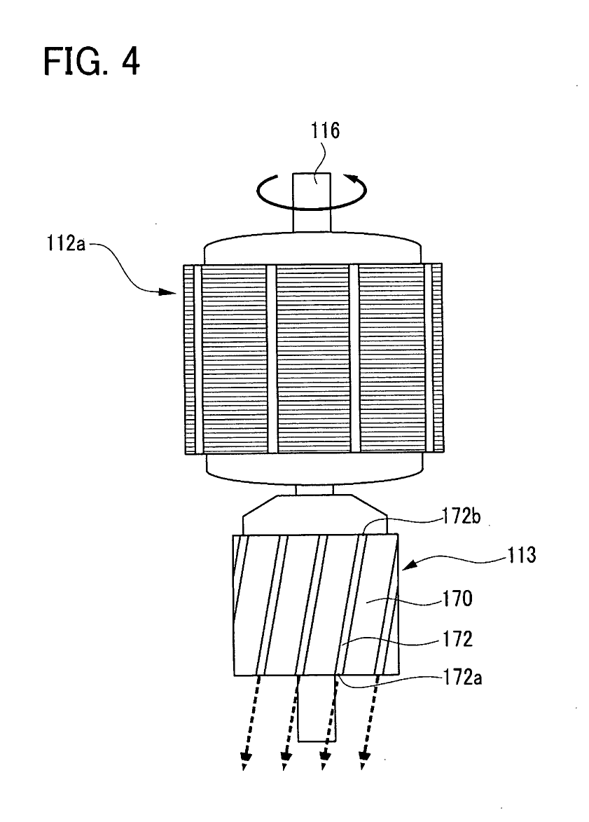

Next, Example 2 will be explained, in which similar or identical parts to those in Example 1 are assigned the same reference signs to those in Example 1 and their details are not explained. The following explanation is thus made with a focus on differences from Example 1. FIG. 4 is a side view of the armature 112a, the commutator 113, and the shaft 116 in Example 2.

As shown in FIG. 4, the commutator 113 is provided, on its outer peripheral surface, with a plurality of segments 170 formed in an inclined direction to the axial direction of the shaft 116 (a vertical direction in FIG. 4). These segments 170 are each plate-shaped conductor materials (metal pieces) and arranged in parallel at equal intervals in a circumferential direction of the commutator 113.

The commutator 113 thus includes inclined grooves 172 formed in the inclined direction with respect to the axial direction of the shaft 116 and arranged one each between adjacent ones of the segments 170 on the outer peripheral surface. An end 172a of each inclined groove 172 on the non-pump side is located at a more forward position in an opposite direction to a rotational direction (a direction indicated by a solid arrow in FIG. 4) of the commutator 113 than an end 172b of each inclined groove 172 on the pump side.

In this Example, when the commutator 113 is rotated during operation of the electric vacuum pump 18, a flow of air is generated in a direction (a direction indicated by broken lines in FIG. 4) toward the non-pump side from the pump side in the motor part 110. This causes the motor foreign matter to flow from the pump side toward the non-pump side in the motor part 110. Thus, the motor foreign matter is much less likely to enter the bearing 130.

### Example 3

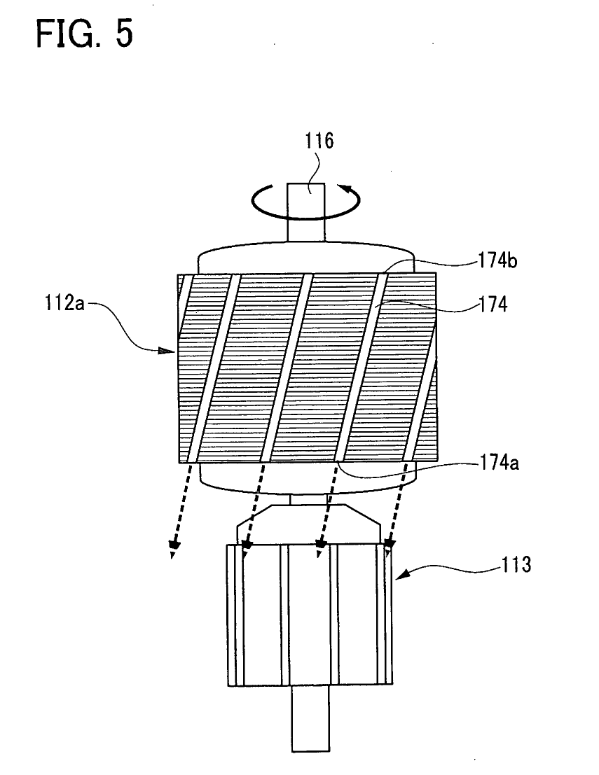

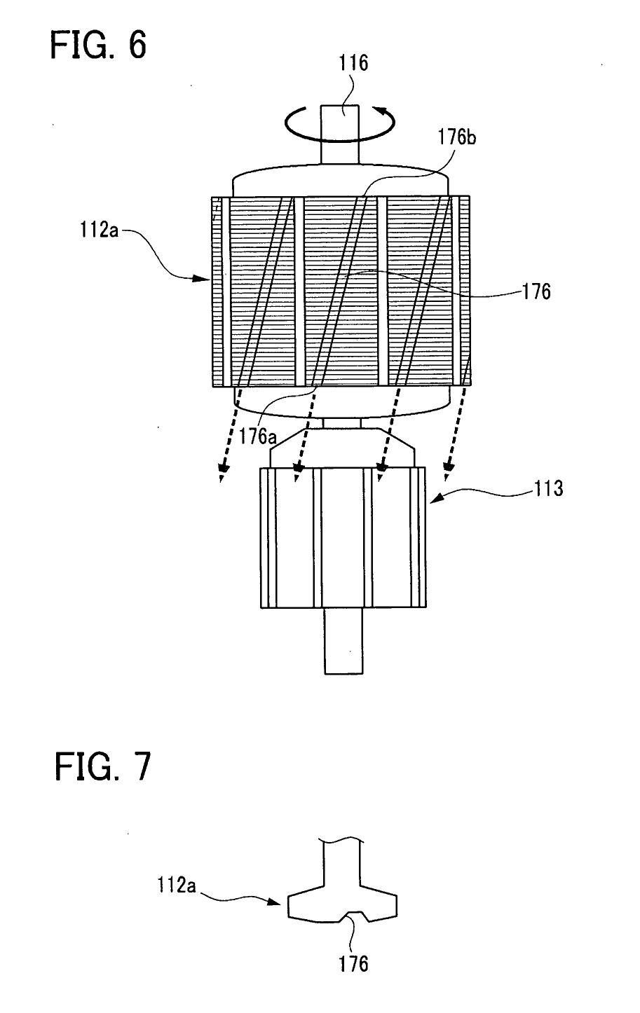

Next, Example 3 will be explained, in which similar or identical parts to those in Examples 1 and 2 are assigned the same reference signs to those in Examples 1 and 2 and their details are not explained. The following explanation is thus made with a focus on differences from Examples 1 and 2. FIGS. 5 and 6 are side views of the armature 112a, the commutator 113, and the shaft 116 in Example 3. FIG. 7 is a part of a top view of the armature 112a shown in FIG. 6.

As shown in FIG. 5, the armature 112a is provided, on its outer peripheral surface, with core openings 174 formed in an oblique direction to the axial direction of the shaft 116 (a vertical direction in FIG. 5). An end 174a of each core opening 174 on the non-pump side is located at a more forward position in an opposite direction to the rotational direction (a direction indicated by a solid arrow in FIG. 5) of the armature 112a than an end 174b of each core opening 174 on the pump side. Herein, the core openings 174 are open areas provided on the outer peripheral surface of the core constituting the armature 112a. The core openings 174 are one example of a “groove” in the present invention.

As a variation, the armature 112a may be provided, on its outer peripheral surface, with inclined grooves 176 in the inclined direction to the axial direction of the shaft 116 (the vertical direction in FIG. 6), as shown in FIGS. 6 and 7. An end 176a of each inclined groove 176 on the non-pump side is located at a more forward position in an opposite direction to the rotational direction (a direction indicated by solid arrow in FIG. 6) of the armature 112a than an end 176b of each inclined groove 176 on the pump side.

In the present example, when the armature 112a is rotated during operation of the electric vacuum pump 18, a flow of air is generated from the pump side toward the non-pump side in the motor part 110. This causes the motor foreign matter to flow from the pump side toward the non-pump side in the motor part 110. Thus, the motor foreign matter is much less likely to enter the bearing 130.

### Example 4

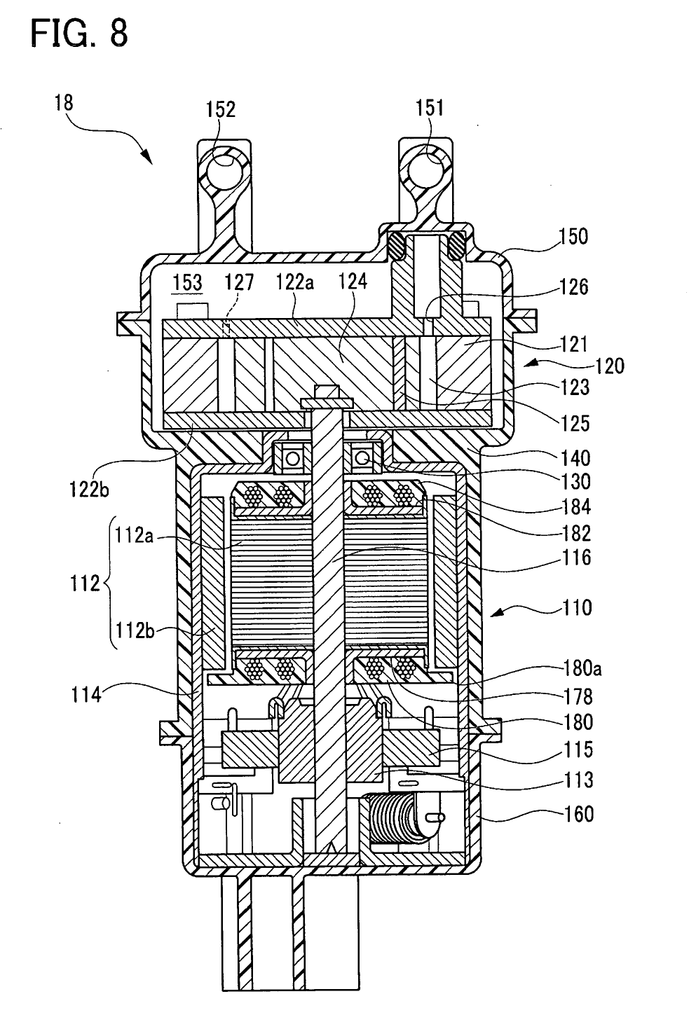

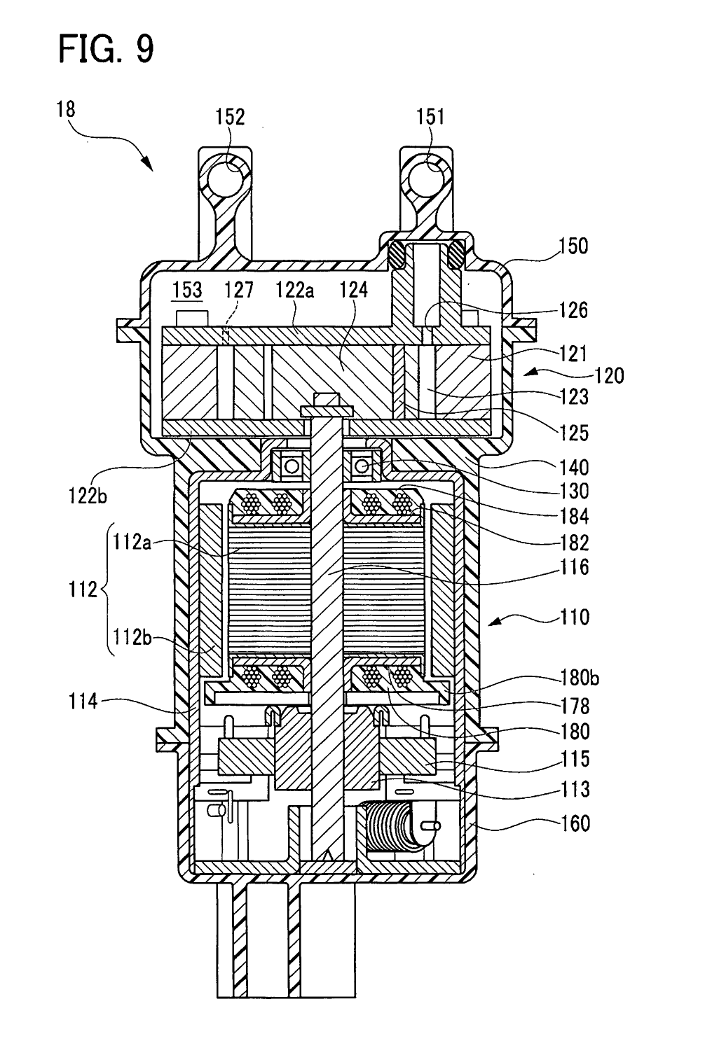

Next, Example 4 will be explained, in which similar or identical parts to those in Examples 1 to 3 are assigned the same reference signs to those in Examples 1 to 3 and their details are not explained. The following explanation is thus made with a focus on differences from Examples 1 to 3. FIGS. 8 and 9 are cross sectional views of an electric vacuum pump 18 in Example 4.

As shown in FIG. 8, an end face 178 of the armature 112a on a side close to the commutator 113 (a lower side in FIG. 8, or the non-pump side) in the axial direction of the shaft 116 is covered with a resin molded part 180 made of resin. The resin molded part 180 is provided, on its outer periphery, with foreign-matter wall 180a formed in a flange shape. Specifically, the foreign-matter wall 180a is formed to protrude more outward than the armature 112a in a radial direction (a lateral direction in FIG. 8) of the armature 112a. The electric vacuum pump 18 in this example includes the foreign-matter wall 180a formed integral with the armature 112a at an end of the armature 112a on the non-pump side. On the other hand, an end face 182 of the armature 112a on a side close to the bearing 130 (an upper side in FIG. 7, or the pump side) in the axial direction of the shaft 116 is covered with a resin molded part 184 made of resin.

As a variation, as shown in FIG. 9, the resin molded part 180 may be provided, on its outer periphery, with a foreign-matter wall 180b formed in a cup-shape. Specifically, the foreign-matter wall 180b is formed to protrude more outward than the outer peripheral surface of the armature 112a in the radial direction (a lateral direction in FIG. 9) of the armature 112 and further protrude more downward than the armature 112a in the axial direction (a downward direction in FIG. 9) of the armature 112a. In this way, the electric vacuum pump 18 of this variation includes the foreign-matter wall 180b formed integral with the armature 112a at an end of the armature 112a on the non-pump side.

The foreign-matter wall 180a and the foreign-matter wall 180b are one example of a “non-pump-side wall member” in the present invention.

In this example, the foreign-matter wall 180a or the foreign-matter wall 180b blocks the motor foreign matter from flowing toward the pump side through gaps between the armature 112a and the magnet 112b. The motor foreign matter is therefore much less likely to enter the bearing 130.

The foreign-matter wall 180a and the foreign-matter wall 180b are each formed in the resin molded part 180 covering the end face 178 of the armature 112a on the non-pump side. This resin molded part 180 can prevent the motor foreign matter from entering the bearing 130 while ensuring insulation in the armature 112a.

### Example 5

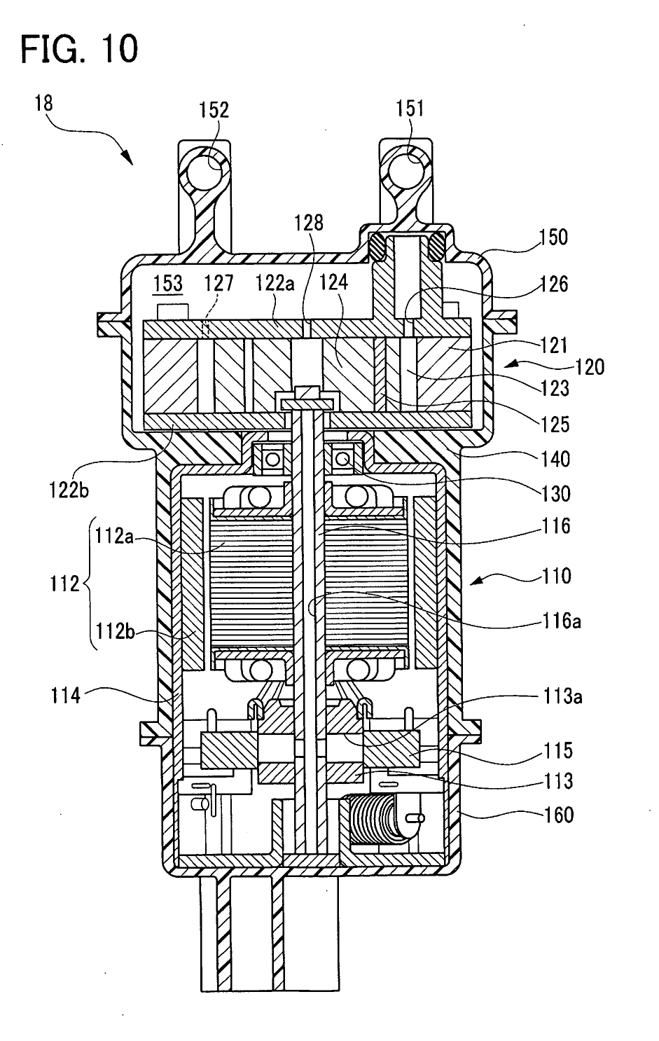

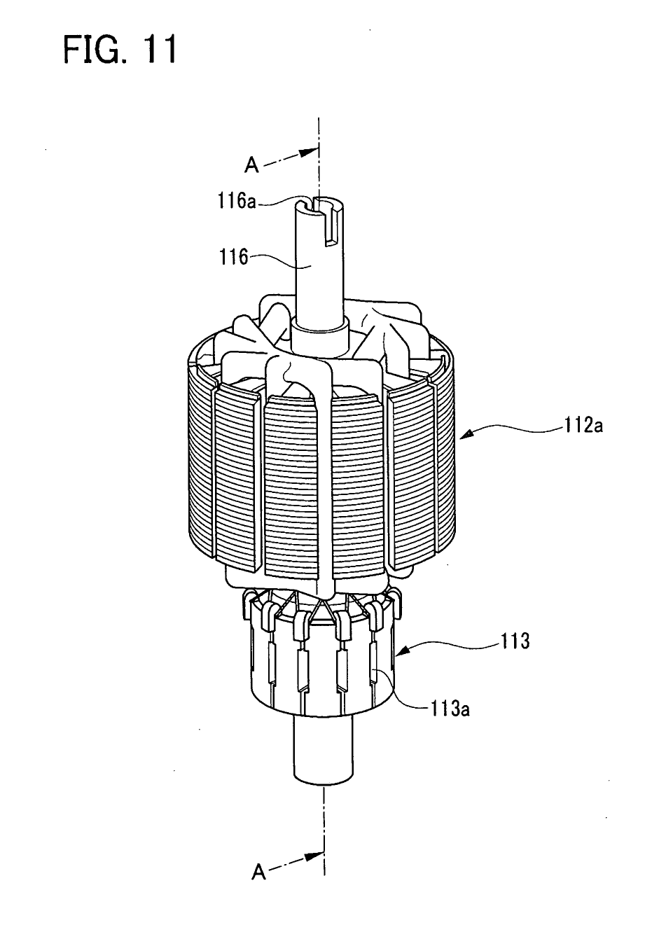

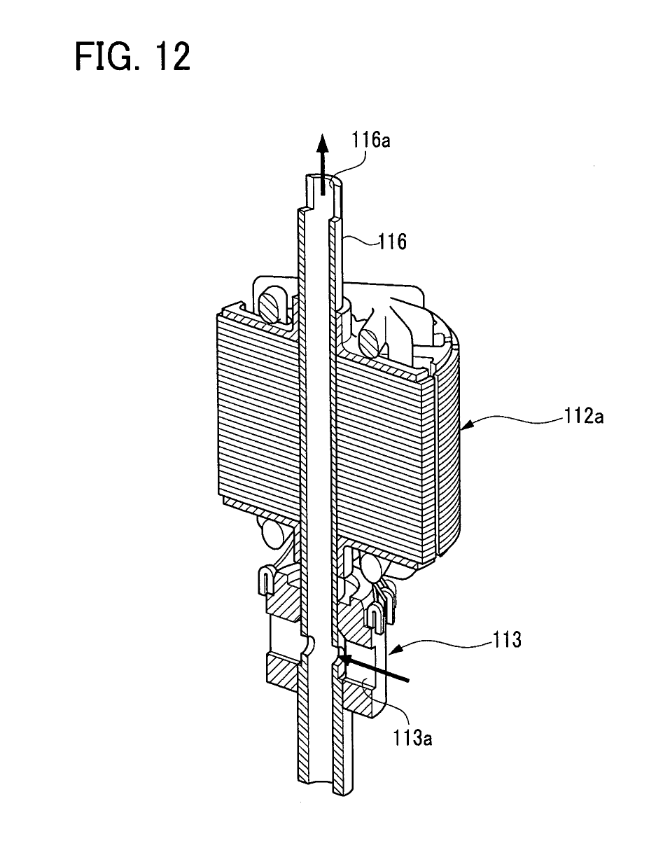

Next, Example 5 will be explained, in which similar or identical parts to those in Examples 1 to 4 are assigned the same reference signs those in Examples 1 to 4 and their details are not explained. The following explanation is thus made with a focus on differences from Examples 1 to 4. Herein, FIG. 10 is a cross sectional view of an electric vacuum pump 18 in Example 5. FIG. 11 is an external perspective view of the armature 112a, the commutator 113, and the shaft 116 in Example 5. FIG. 12 is a cross sectional view taken along A-A in FIG. 11.

As shown in FIGS. 10 to 12, the shaft 116 is internally formed with an abrasion powder passage 116a. This passage 116a communicates with the commutator 113 and the rotor 124 of the pump part 120. The commutator 113 is formed with a through hole 113a.

The cover member 122a of the pump part 120 includes a foreign matter discharge hole 128. This hole 128 communicates with inside and outside of the pump part 120.

In this example, the negative pressure generated in the pump part 120 allows the motor foreign matter to pass through the through hole 113a of the commutator 113, the abrasion powder passage 116a, the rotor 124, and the foreign matter discharge hole 128 as indicated by solid arrows in FIG. 12, and flow, or is discharged, into the silencer 153 outside the pump part 120. The motor foreign matter is therefore much less likely to enter the bearing 130. The motor foreign matter coming into the silencer 153 is discharged out of the electric vacuum pump 18 through the discharge port 152.

### Example 6

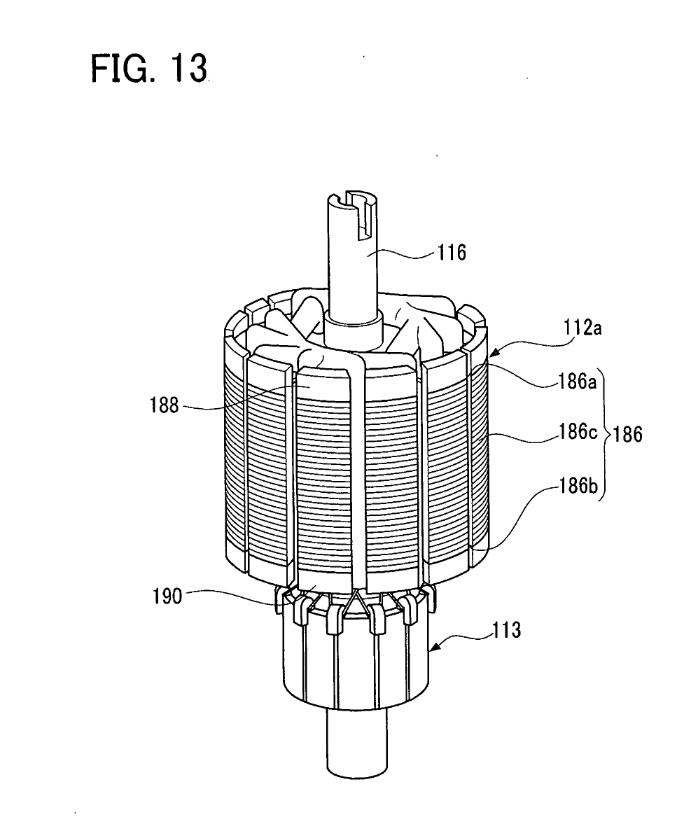

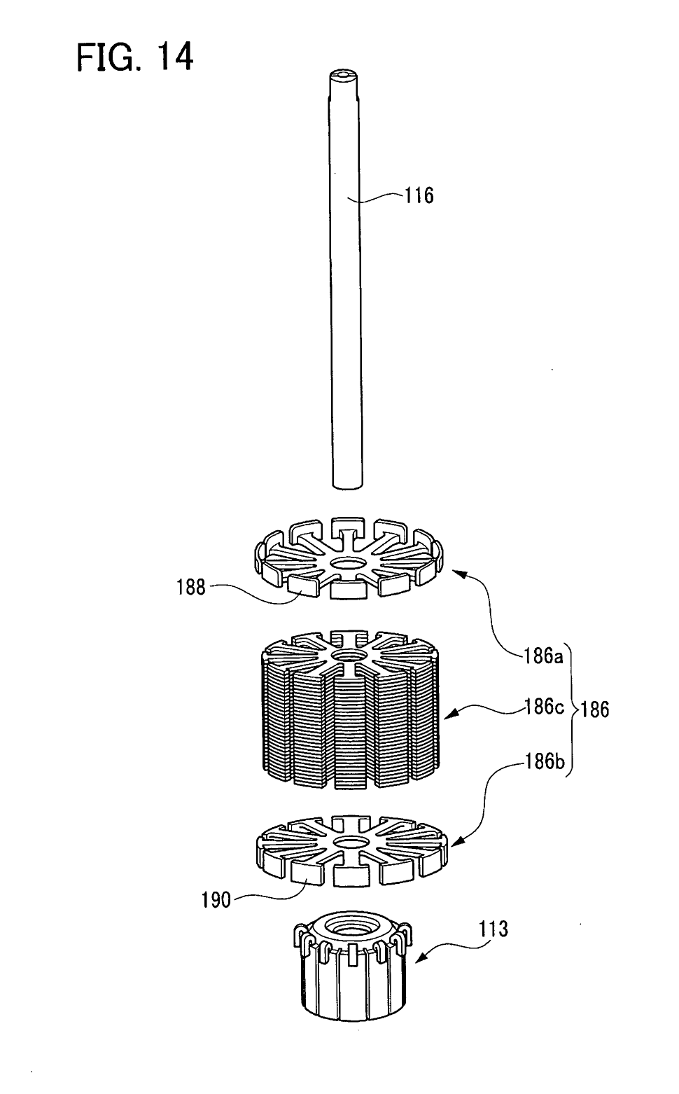

Next, Example 6 will be explained, in which similar or identical parts to those in Examples 1 to 5 are assigned the same reference signs to those in Examples 1 to 5 and their details are not explained. The following explanation is thus made with a focus on differences from Examples 1 to 5. FIG. 13 is an external perspective view of the armature 112a, the commutator 113, and the shaft 116 in Example 6. FIG. 14 is an exploded perspective view of the armature 112a, the commutator 113, and the shaft 116 in Example 6.

As shown in FIGS. 13 and 14, a core 186 of the armature 112a includes an upper core member 186a, a lower core member 186b, and a group of intermediate core members 186c.

Of a plurality of thin plate-like core members stacked constituting the core 186, the upper core member 186a is a core member located at a position closest to the bearing 130 (an upper side in FIG. 13, or the pump side). The upper core member 186a is formed, on its outer periphery, with a wall part 188 vertically extending along the axial direction of the shaft 116. That is, the wall part 188 is formed to protrude in the axial direction (an upward direction in FIG. 13) of the armature 112a. In this way, the electric vacuum pump 18 of the present example includes the wall part 188 formed integral with the armature 112a at an end of the armature 112a on the pump side. The wall part 188 is one example of a “pump-side wall member” in the present invention.

Of the plurality of thin plate-like core members stacked constituting the core 186, the lower core member 186b is a core member located at a position closest to the commutator 113 (a lower side in FIG. 13, or the non-pump side). The lower core member 186b is formed, on its outer periphery, with a wall part 190 vertically extending along the axial direction of the shaft 116. That is, the wall part 190 is formed to protrude in the axial direction (a lower direction in FIG. 13) of the armature 112a. In this way, the electric vacuum pump 18 of the present example includes the wall part 190 formed integral with the armature 112a at an end of the 112a on the non-pump side. The wall part 190 is one example of a “non-pump-side wall member” in the present invention.

In the present example, the wall part 188 of the upper core member 186a and the wall part 190 of the lower core member 186b block the motor foreign matter from flowing toward the pump side. Thus, the motor foreign matter is much less likely to enter the bearing 130.

The above embodiment is a mere example and does not particularly limit the invention. Thus, the present invention may be embodied in other specific forms without departing from the essential characteristics thereof. For instance, Examples 1 to 6 may be combined in various combinations.

### REFERENCE SIGNS LIST

1 Brake system
12 Brake booster
18 Electric vacuum pump
110 Motor part
112 Electric motor
112a Armature
113 Commutator
113a Through hole
114 Motor case
115 Brush
116 Shaft
116a Abrasion powder passage
120 Pump part
124 Rotor
128 Foreign-matter discharge hole
130 Bearing
140 Case
150 Upper cover
160 Lower cover
170 Segment
172 Inclined groove
172a End on non-pump side
172b End on pump side
174 Core opening
174a End on non-pump side
174b End on pump side
176 Inclined groove
176a End on non-pump side
176b End on pump side
178 End face
180 Resin molded part
180a Foreign-matter wall
180b Foreign-matter wall
182 End face
184 Resin molded part
186 Core
186a Upper core member
186b Lower core member
186c Intermediate core members
188 Wall part
190 Wall part

What is claimed is:

1. An electric vacuum pump including:
a rotary member including an armature and a commutator;
a brush arranged to slide in contact with the commutator;
a motor part provided with a rotary shaft integral with the rotary member;
a pump part connected to the rotary shaft and configured to operate in sync with the motor part; and
a bearing supporting the rotary shaft between the motor part and the pump part,
the commutator and the brush being placed on a non-pump side opposite to a pump side on which the pump part is placed in an axial direction of the rotary shaft with respect to the armature.

2. The electric vacuum pump according to claim 1, wherein
the rotary member is provided on its outer peripheral surface with a groove extending in an inclined direction to the axial direction of the rotary shaft, and
an end of the groove on the non-pump side is located at a more forward position in an opposite direction to a rotational direction of the rotary member than an end of the groove on the pump side.

3. The electric vacuum pump according to claim 1, wherein
the armature includes a non-pump-side wall member formed integral with the armature at an end of the armature on the non-pump side, and
the non-pump-side wall member protrudes at least one of an axial direction and a radial direction of the armature.

4. The electric vacuum pump according to claim 1, wherein
the rotary shaft is provided with a communication passage providing communication between the commutator and the pump part, and
the pump part includes a communication hole providing communication between inside and outside of the pump part.

5. The electric vacuum pump according to claim 3, wherein the non-pump-side wall member is formed in a resin molded part covering an end face of the armature on the non-pump side.

6. The electric vacuum pump according to claim 3, wherein
the armature includes a pump-side wall member formed integral with the armature at an end of the armature on the pump side,
the armature includes a core formed of stacked plate-like core members,
the pump-side wall member is formed in the core member located at a position closest to the pump side, and
the non-pump-side wall member is formed in the core member located at a position closest to the non-pump side.
